(19) United States
(12) Patent Application Publication
(10) Pub. No.: US 2007/0149192 A1
(43) Pub. Date: Jun. 28, 2007

(54) Idle state terminal location information update device and method

(75) Inventors: Eun-Kyung Kim, Daejeon City (KR); Kyung-Soo Kim, Daejeon-City (KR)

Correspondence Address: THE FARRELL LAW FIRM, P.C., 333 EARLE OVINGTON BOULEVARD, SUITE 701, UNIONDALE, NY, 11553, US

(73) Assignees: SAMSUNG ELECTRONICS CO., LTD., Suwon-si (KR); Electronics and Telecommunications Research Institute, Daejeon (KR); KT Corporation, Seongnam-city (KR); SK TELECOM CO., LTD, Seoul (KR); HANARO TELECOM., INC., Seoul (KR)

(21) Appl. No.: 11/635,112

(22) Filed: Dec. 7, 2006

(30) Foreign Application Priority Data
Dec. 7, 2005 (KR) 2005-118756

(51) Int. Cl. H04Q 7/20

(52) U.S. Cl. 455/435.1; 455/433

(57) ABSTRACT

A device and method for updating location information of an idle state terminal in a communication system supporting an idle state of a terminal are provided. In the method, an expectation time for updating the location information is calculated according to a moving speed of the terminal, when a state of the terminal is changed to an active state to the idle state, the calculated expectation time is registered to a paging timer, and the paging timer is operated, the location information of the terminal is updated when the paging timer expires.

### PRIORITY

This application claims priority to and the benefit of Korean Patent Application No. 10-2005-0118756 filed in the Korean Intellectual Property Office on Dec. 7, 2005, the contents of which are incorporated herein by reference.

### BACKGROUND OF THE INVENTION

1. Field of the Invention

The present invention relates to a device and method for updating location information of an idle state terminal in a communication system supporting an idle state of a terminal.

2. Description of the Related Art

In response to the increase in the number of users transmitting/receiving data while moving around, a communication system based on a wideband wireless access communication network has been provided.

For example, an IEEE 802.16 wireless metropolitan area network (MAN)-based communication system is a 3.5^{th} mobile communication system, in which high-speed packet data including Internet protocol (IP)-based wireless data services (e.g., a streaming video service, a file transfer protocol (FTP) service, a mail service, and a chatting service) are provided by using a wired transmission scheme for guaranteeing spectrum efficiency in a 2.3 GHz frequency bandwidth. In this communication system, when a terminal does not receive service for a predetermined time, the terminal returns resources and performs basic functions to reduce power consumption. That is, in this communication system, an idle mode is defined, in which the terminal uses minimum power and intermittently registers a location of the terminal to reduce the number of messages transmitted in a wireless link. In addition, the communication system has a cell-based mobile communication configuration, and supports a hand-over method.

As shown in FIG. 1, a handover is performed to guarantee mobility and communication quality when a terminal 1 moves from a cell 10 of a base station BS1 to a cell 20 of a base station BS2. In this case, the base station BS1 to which the terminal 1 is currently accessed will be referred to as a serving base station, and the base station BS2 to which the terminal is moved will be referred to as a target base station.

As shown in FIG. 2, when the terminal 1 needs to perform the handover, the terminal 1 transmits a handover request message HO-REQ to the serving base station BS1 to request the handover in step S21. The serving base station BS1 receiving the handover request message HO-REQ determines whether the target base station BS2 may accept the handover of the terminal 1, and transmits a handover response message HO-REP to transmit a list including at least one of target base stations to which the terminal 1 may perform the handover in step S22. The terminal 1 receives the handover response message HO-REP, selects one target base station from the list of target base stations, transmits a handover indication message HO-IND to inform the serving base station BS1 of the selected target base station in step S23, and moves to the corresponding target base station BS2 in step S24. Thereby, an initial wireless access process is performed between the terminal 1 and the target base station BS2 in step S25. However, when there are many terminals or handover is frequently performed, a network load may be caused by the initial wireless access process.

Accordingly, a paging method has been provided, in which the terminal does not frequently register its location to the base station in the initial wireless access process to reduce the network load and to reduce the power consumption of the terminal. That is, a network manages the location of the terminal 1, and detects the location of the terminal 1 by performing a paging operation when there are data to be transmitted. Accordingly, as shown in FIG. 3, the communication system includes paging groups P#1 and P#2, and updates terminal location information for an idle state terminal with respect to the paging groups P#1 and P#2.

Of the conventional methods for updating the terminal location information, there are a periodic update method for updating the location information in a predetermined time and a paging group-based update method for updating the location information when the terminal leaves the paging group.

FIG. 4 shows a diagram representing the periodic update method. When a state of the terminal is changed from an active state to an idle state in steps S41 and S42, a paging timer is driven in step S43, and the state is changed to the idle state in step S44. Subsequently, when data are generated from the base station in step S45, the terminal returns to the active state to perform data communication in step S41. When the paging timer driven in the idle state expires in step S46, the location information of the idle state terminal is updated in step S47, and the paging timer is driven in step S43.

FIG. 5 shows a diagram representing the paging group-based update method. When the state of the terminal is changed from the active state to the idle state in steps S51 and S52, a paging group currently including the terminal is registered in step S53, and the state of the terminal is changed to the idle state in step S54. Subsequently, when data are generated from the base station in step S55, the terminal returns to the active state to perform the data communication in step S51. When the terminal in the idle state moves from the registered paging group to another paging group in step S56, the terminal location information is updated in step S57, and the current paging group is registered in step S53.

In the periodic update method and the paging group-based update method, unnecessary network load may be reduced. However, an unnecessary update operation may be performed when a moving speed of the terminal is slow and the location information is periodically updated, and the number of update operations may be increased when the moving speed is fast and the location information is updated based on the paging group. Accordingly, network performance may deteriorate due to the unnecessary network load and frequent load.

### SUMMARY OF THE INVENTION

The present invention has been made in an effort to provide an idle state terminal location information update device for improving access network performance by efficiently performing a paging operation according to a moving speed of a terminal.

According to one aspect of the present invention, a device for updating location information of an idle state terminal in a communication system supporting an idle state is provided, and the device includes a terminal location notifying unit, a paging timer registering unit, and a location information update unit. The terminal location notifying unit obtains the location information of the terminal based on the terminal and a base station of covering the terminal. The paging timer registering unit calculates an expectation time for updating the location information based on a speed of the terminal and the location information of the terminal, registers the expectation time to a paging timer, and operates the paging timer when a state of the terminal is changed to an active state to the idle state. The location information update unit updates the location information when the paging timer is expired.

According to another aspect of the present invention, a method for updating location information of an idle state terminal in a communication supporting an idle state is provided, the method including calculating an expectation time according to a moving speed of the terminal; when a state of the terminal is changed to an active state to the idle state, registering the calculated expectation time to a paging timer, and operating the paging timer; and updating the location information of the terminal is when the paging timer expires.

According to still another aspect of the present invention, a device for updating location information of an idle state terminal in a communication system supporting an idle state is provided, the device including a means for obtaining the location information of the terminal based on the terminal and a base station covering the terminal, means for calculating an expectation time for updating the location information of the terminal based on the location information of the terminal, and means for updating the location information of the terminal when the state of the terminal is changed to the idle state and the expectation time lapses.

The expectation time is calculated from the location information of the terminal and a moving speed of the terminal. In addition, a distance from a current location of the terminal to a location where the location information is subsequently updated is calculated, and the expectation time is calculated from the calculated distance and the speed of the terminal.

The device further includes means for registering a paging group including the terminal, wherein the paging group comprises one or more base stations.

The location information includes a distance from the base station covering the terminal to the terminal, a distance from the paging group including the terminal to a boundary of another paging group to which the terminal is moved, and an angle between a moving direction of the terminal and the base station covering the terminal.

In addition, the location information of the terminal is updated when the terminal moves from the registered paging group to the other paging group.

### BRIEF CENTER DESCRIPTION OF THE DRAWINGS

The above and other objects, features and advantages of the present invention will be more apparent from the following detailed description taken in conjunction with the accompanying drawings in which:

FIG. 1 is a diagram representing a handover operation of a terminal in a communication system;

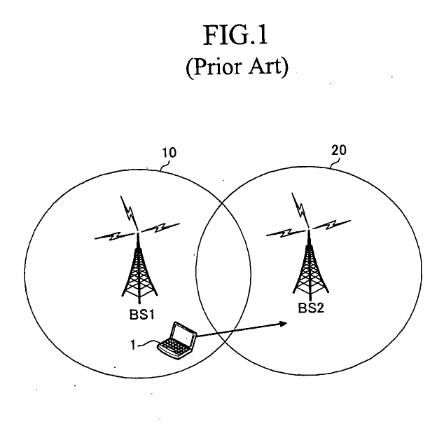

FIG. 2 is a diagram representing a handover process of the terminal in the communication system;

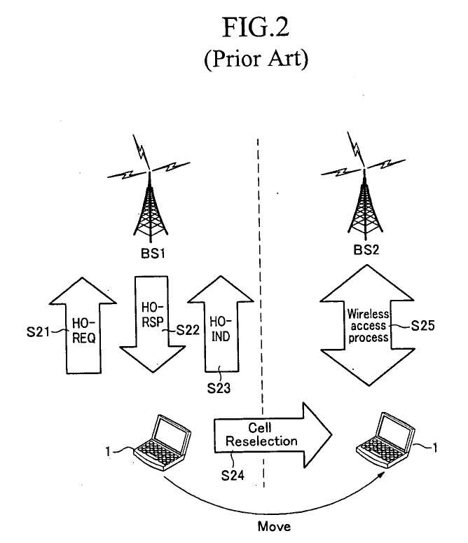

FIG. 3 is a diagram representing an idle state terminal performing the handover operation from a paging group to another paging group in the communication system;

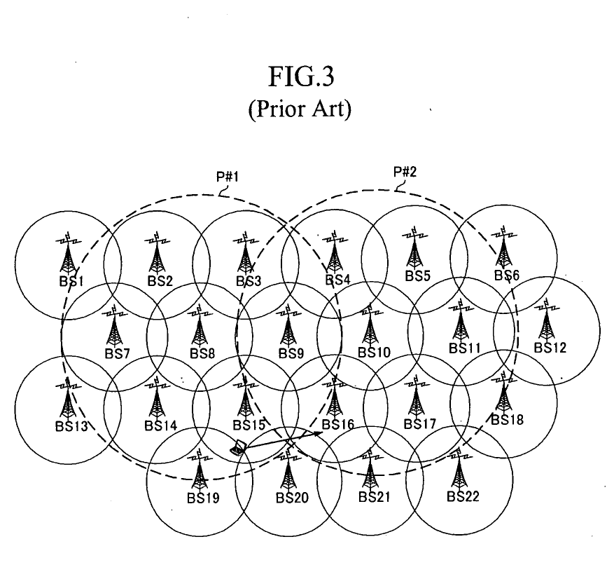

FIG. 4 is a flow chart of a periodic update method;

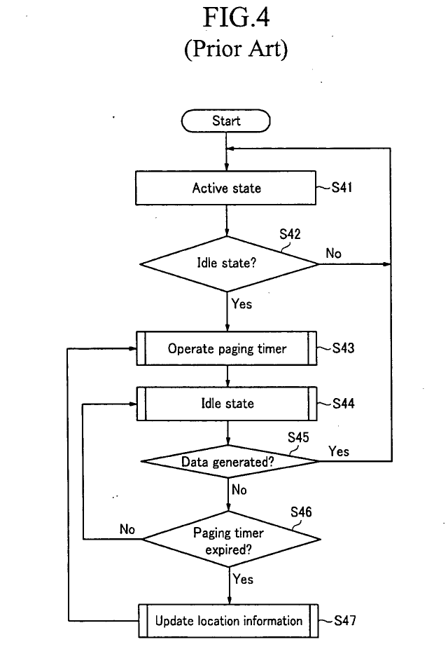

FIG. 5 is a flow chart of a paging group-based update method;

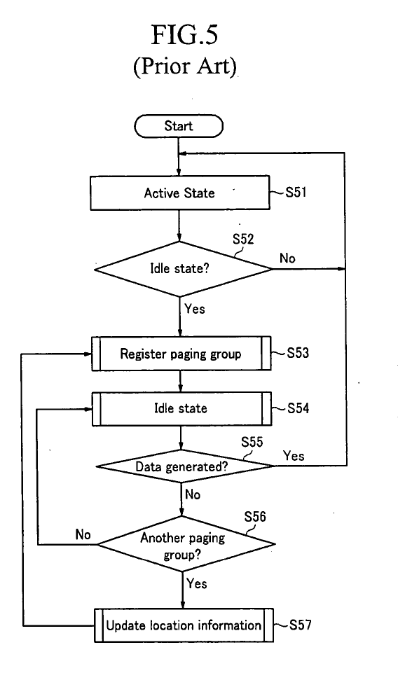

FIG. 6 is a diagram representing a communication system according to the exemplary embodiment of the present invention;

FIG. 7 is a block diagram of an idle state terminal location information update device in the communication system according to the exemplary embodiment of the present invention;

FIG. 8 is a diagram representing the handover of the idle state terminal from one paging group to another paging group; and

FIG. 9 is a flowchart of an operational process of a location information update device in the communication system according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various ways, all without departing from the spirit or scope of the present invention. Accordingly, the drawings and description are to be regarded as illustrative in nature and not restrictive. Like reference numerals designate like elements throughout the specification.

A device for updating location information of an idle state terminal in a communication system according to the present invention and a method thereof will be described with reference to the figures. In the present invention, an IEEE 802.16 wireless metropolitan area network (MAN)-based communication system is exemplified, but it is not limited thereto, and another communication system may be applied.

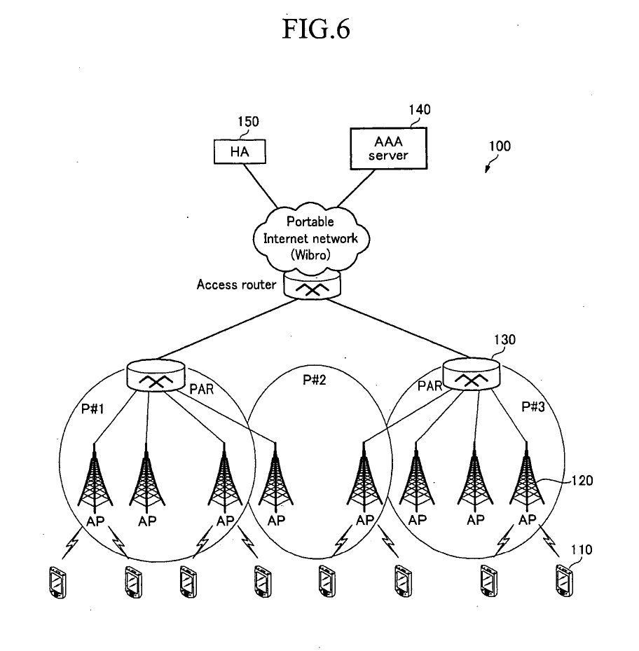

FIG. 6 is a diagram representing the communication system according to an exemplary embodiment of the present invention.

As shown in FIG. 6, an access terminal (AT) 110, an access point (AP) 120, a packet access router (PAR) 130, an authentication, authorization and accounting (AAA) server 140, and a home agent (HA) 150 are provided.

The AT 110 is used by a subscriber to receive a communication service. In addition, the AT 110 performs radio channel transmitting/receiving functions in a 2.3 GHz band frequency according to a wireless access standard to access to the AP 120 and transmit/receive high packet data.

The AP 120 connects a wireless network and a wired network, and provides a wireless packet data service to the AT 110 from an end of the wired network through a wireless interface. That is, the AP 120 receives a wireless signal from the AT 110 and transmits it to the PAR 130, or the AP 120 receives information from the PAR 130, converts it into the wireless signal, and transmits the signal to the AT 110.

The PAR 130 accesses the plurality of APs 120 based on Internet protocol (IP), and accesses an IP network of a service provider to access a public Internet. In addition, the PAR 130 controls the AT 110 and the AP 120 and performs a routing operation for an IP packet.

The AAA server 140 performs an AAA function for a user and the AT 110 to allow an appropriate user to access a portable Internet network and to provide a service. The AAA server 140 may use a diameter protocol standardized by an international standard organization, Internet Engineer Task Force (IETF). The diameter protocol allows AAA information to be transmitted between servers.

The HA 150 accesses the IP network of the service provider to perform a mobile IP service function. That is, the HA 150 supports IP mobility of the AT 110 in a home network.

One or more base stations form one paging group in the communication system 100, as the AT 110 moves around cells, a handover operation for changing the AP 120 providing a service to the AT 110 is performed. In addition, since the communication system manages the paging groups P#1, P#2, and P#3 when the handover of the AT 110 is performed, location information of an idle state AT is updated.

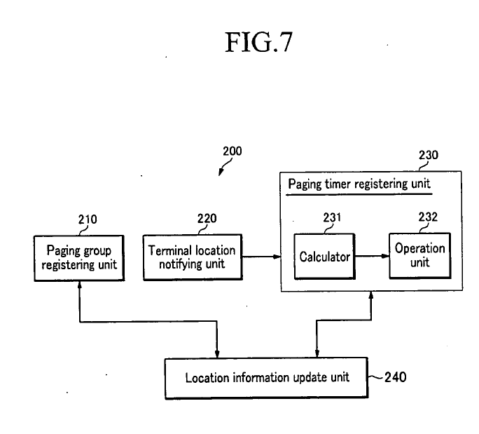

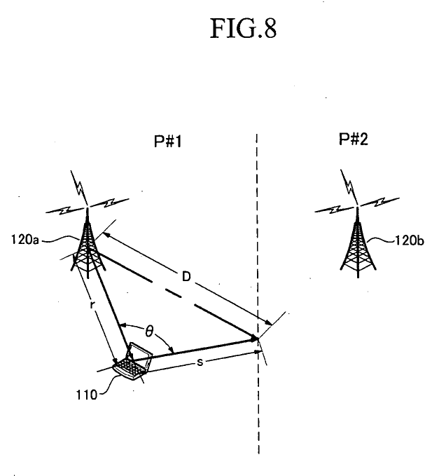

FIG. 7 is a block diagram of an idle state AT location information update device in the communication system according to the exemplary embodiment of the present invention, and FIG. 8 is a diagram representing the handover of the idle state AT from one paging group to another paging group. In FIG. 8, a serving AP of a paging group P#1 communicating with a current AT 110 is denoted by 120a, and a target AP of a paging group P#2 is denoted by 120b.

As shown in FIG. 7, the idle state AT location information update device 200 includes a paging group registering unit 210, a terminal location notifying unit 220, a paging timer registering unit 230, and a location information update unit 240. The paging timer registering unit 230 includes a calculator 231 and an operation unit 232.

The paging group registering unit 210 registers a paging group currently covering the idle state AT 110.

The terminal location notifying unit 220 transmits the idle state AT location information obtained based on the idle state AT 110 and the AP 120a covering the idle state AT 110 to the calculator 231 of the paging timer registering unit 230. As shown in FIG. 8, the idle state AT location information may include a distance γ. from the AP 120a of the paging group covering the idle state AT 110 to the AT 110, an angle θ of a moving direction of the idle state AT 110 and the AP 120a, and a distance D from the paging group P#1 including the idle state AT 110 to a boundary of the paging group P#2, i.e., from the AP120a to a boundary of the paging group P#2.

The calculator 231 of the paging timer registering unit 230 uses a current speed of the idle state AT 110 and the idle state AT location information transmitted from the terminal location notifying unit 220 to calculate an expectation time for updating the location information. The operation unit 232 registers the calculated expectation time to a timer to establish an expiration time, and operates the timer when the state of the AT 110 is changed from the active state to the idle state.

When the timer expires, the location information update unit 240 updates the location information of the idle state AT 110. In addition, the location information update unit 240 detects movement of the idle state AT 110 from the paging group registered to the paging group registering unit 210 to another paging group, and updates the location information of the idle state AT 110 that is moved to the other paging group.

A method for calculating the expectation time for updating the location information by the calculator 231 will be described. A distance S from a current location of the idle state terminal to a location where the location is subsequently updated is calculated based on the distance γ, the angle θ, and the distance D. The distance s may be calculated as Equation (1).
D²=γ²+s²−2rs cos θ (1)

The location information update expectation time t is calculated based on the distance s calculated by Equation (1) and the moving speed v of the idle state AT 110. That is, the location information update expectation time may be calculated as Equation (2).

$$t = \frac{s}{v} \qquad ( 2 )$$

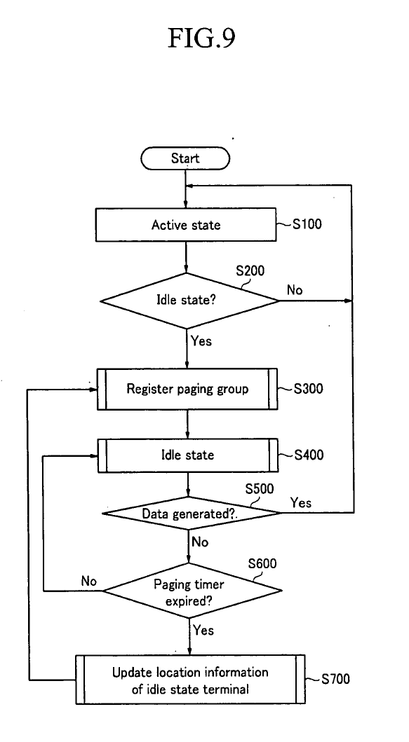

An operation of the idle state AT location information update device according to the exemplary embodiment of the present invention will be described with reference to FIG. 9.

FIG. 9 shows a flowchart representing an operational process of the location information update device in the communication system according to the exemplary embodiment of the present invention.

As shown in FIG. 9, when the state of the AT 110 is changed from the active state to the idle state in steps S100 and S200, the idle state AT location information update device 200 registers the idle state AT location information update expectation time, which is calculated by Equation (1) and Equation (2), to the paging timer, establishes the expiration according to the expectation time, and operates the paging timer in step S300.

Subsequently, when data are generated from the AP 120a, the AT 110 returns to the active state to perform the data communication in step S100. When data are not generated and the timer expires in step S600, the idle state AT location information update device 200 updates the location information of the idle state AT 110 in step S700. The paging group is registered and the location information update device 200 operates the paging timer in step S300. The location information update device 200 repeatedly performs the steps S100 to S700 to update the location information of the idle state AT 110.

According to the exemplary embodiment of the present invention, since the communication system supporting the idle state updates the location information according to the speed of the access terminal, an unnecessary location information update operation may not be performed. Accordingly, the network load may be reduced and the power consumption of the access terminal may be reduced.

The above-described methods and apparatuses are not only realized by the exemplary embodiment of the present invention, but, on the contrary, are intended to be realized by a program for realizing functions corresponding to the configuration of the exemplary embodiment of the present invention or a recording medium for recording the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A device for updating location information of an idle state terminal in a communication system supporting an idle state, the device comprising:
a terminal location notifying unit for obtaining location information of the terminal based on the terminal and a base station covering the terminal;
a paging timer registering unit for calculating an expectation time for updating the location information based on a speed of the terminal and the location information of the terminal, registering the expectation time to a paging timer, and operating the paging timer when a state of the terminal is changed from an active state to the idle state; and
a location information update unit for updating the location information when the paging timer expires.

2. The device of claim 1, wherein the paging timer registering unit comprises:
a calculator for calculating a distance from a current location of the terminal to a location where the location information is subsequently updated based on the location information, and calculating the expectation time based on the calculated distance and the speed of the terminal; and
an operation unit for registering the expectation time to the paging timer and operating the paging timer.

3. The device of claim 1, wherein the location information includes a distance from the base station covering the terminal to the terminal, a distance from a paging group including the terminal to a boundary of another paging group to which the terminal is moved, and an angle between a moving direction of the terminal and the base station covering the terminal.

4. The device of claim 3, further comprising a paging group registering unit for registering the paging group including the terminal,
wherein the location information update unit updates the location information of the terminal moving from the registered paging group to the other paging group.

5. A method for updating location information of an idle state terminal in a communication supporting an idle state, the location information update method comprising:
calculating an expectation time for updating location information of the terminal according to a moving speed of the terminal;
registering the calculated expectation time to a paging timer when a state of the terminal is changed from an active state to the idle state;
operating the paging timer; and
updating the location information of the terminal when the paging timer expires.

6. The method of claim 5, wherein calculating of the expectation time comprises:
calculating a distance from a current location of the terminal to a location where the location information is subsequently updated, based on a distance from a base station covering the terminal to the terminal, a distance from a paging group including the terminal to a boundary of another paging group to which the terminal is moved, and an angle between a moving direction of the terminal and the base station covering the terminal; and
calculating the expectation time based on the calculated distance and the moving speed of the terminal.

7. The method of claim 6, further comprising:
operating the paging timer again after updating the location information of the terminal.

8. A device for updating location information of an idle state terminal in a communication system supporting an idle state, the location information update device comprising:
means for obtaining location information of the terminal based on the terminal and a base station covering the terminal;
means for calculating an expectation time for updating the location information of the terminal based on the location information of the terminal; and
means for updating the location information of the terminal when the state of the terminal is changed to the idle state and the expectation time lapses.

9. The device of claim 8, wherein the means for calculating calculates the expectation time from the location information of the terminal and a speed of the terminal.

10. The device of claim 8, wherein the means for calculating calculates a distance from a current location of the terminal to a location where the location information is subsequently updated, and calculates the expectation time from the calculated distance and the speed of the terminal.

11. The device of claim 8, further comprising means for registering a paging group including the terminal,
wherein the paging group comprises at least one base station.

12. The device of claim 11, wherein the location information of the terminal includes:
a distance from the base station covering the terminal to the terminal;
a distance from the paging group including the terminal to a boundary of another paging group to which the terminal is moved; and
an angle between a moving direction of the terminal and the base station covering the terminal.

13. The device of claim 11, wherein the means for updating updates the location information of the terminal when the terminal moves from the registered paging group to the other paging group.
